(19) United States
(12) Patent Application Publication
(10) Pub. No.: US 2026/0051784 A1
(43) Pub. Date: Feb. 19, 2026

(54) ELECTRIC MOTOR ROTOR ASSEMBLY

(71) Applicant: Vibracoustic SE, Weinheim (DE)

(72) Inventors: Jessica Trumpfheller, Brombachtal (DE); Niklas Müller, Ihringen (DE); Daniel Sappok, Viernheim (DE); Kjell Jonsson, Bredaryd (SE); Manuel Muser, Buggingen (DE); Markus Dürre, Neuenburg am Rhein (DE)

(21) Appl. No.: 19/101,179

(22) PCT Filed: Jul. 31, 2023
(86) PCT No.: PCT/EP2023/071126

§ 371 Date: Jun. 24, 2025

(30) Foreign Application Priority Data
Aug. 5, 2022 (DE) 102022119704.2

(51) Int. Cl. H02K 5/24

(52) U.S. Cl. CPC H02K 5/24

(57) ABSTRACT

An electric motor rotor assembly has a central longitudinal axis that runs through the electric motor rotor assembly, at least two structural elements that are arranged coaxially with respect to the central longitudinal axis, and at least one spring element that is arranged between the at least two structural elements in a radial direction and connects the corresponding structural elements such that they are movable relative to each other.

### CROSS-REFERENCE TO RELATED APPLICATIONS

This application is a National Phase application claiming priority to International Patent Application No. PCT/EP2023/071126, filed on Jul. 31, 2023, and German Patent Application No. DE 102022119704.2, filed on Aug. 5, 2022, the contents of both of which are hereby incorporated by reference in their entirety.

### TECHNICAL FIELD

The invention relates to an electric motor rotor assembly.

### BACKGROUND

Electric motors comprise a stator and a rotor. The usually one-piece rotor can, as a rotating part, be subject to noise, vibration, and ride vibration. However, known rotors have inadequate NVH properties (noise, vibration, harshness).

A first NVH source can exist in the electric motor itself. A torque ripple (torsional vibration) can be imparted to the rotating rotor by fluctuations in magnetic fields or torque pulses. A second NVH source can exist in the transmission of noise and vibration via a structure along a vibration path. Torsional vibration is transmitted via a transmission, a differential, and a side shaft or shaft as well as the motor and/or transmission housing. The motor and/or transmission housing emits airborne noise. Drive train vibration can cause airborne noise at the connected components along their length.

No satisfactory solution is known to date for effectively avoiding or reducing noise and vibration of the rotor which is transmitted to the body or the wheels.

### SUMMARY

An object of the invention is improvement of the prior art.

Aspects and features of the invention are disclosed herein.

According to the invention, an electric motor rotor assembly is proposed, comprising a central longitudinal axis which traverses the electric motor rotor assembly, at least two structural elements which are arranged coaxially with respect to the central longitudinal axis, wherein the electric motor rotor assembly comprises at least one spring element which is arranged between the at least two structural elements in a radial direction and connects the corresponding structural elements to each other so that they can move relatively.

The inherently rigid rotor from the prior art is supplemented by torsional elasticity generated by the spring element. An electric motor rotor assembly is thus provided which is divided into two structural elements which can move relative to each other and can be understood as or take the form of a mass. The structural elements can be rigid structural elements. Such vibration decoupling means that noise and vibration cannot be transmitted via the rotor along a vibration path along which vibration is transmitted.

The structural elements can be separate components such as, for example, a rotor shaft and a rotor base body. The first and second structural elements can, however, also be portions of a single component such as, for example, an inner radial rotor shaft portion and an outer radial rotor shaft portion. This shows the variability of the invention. Because of the coaxial arrangement, the longitudinal axes of the structural elements and the central longitudinal axis coincide congruently.

The structural elements can be arranged coaxially, wherein one of the two structural elements is arranged on the outer circumference of the other structural element. The spring element is arranged in the radial gap between the two structural elements. The spring element can be an elastomeric sleeve.

According to one conceivable embodiment of the electric motor rotor assembly, it can also comprise three structural elements, for example a rotor shaft, a rotor base body, and a transmission input gearwheel. It is conceivable that the three structural elements are arranged one behind the other with respect to a vibration path, preferably one immediately behind the other. Two of the structural elements can thus, for example, be connected to the third structural element via in each case one spring element.

According to one conceivable embodiment of the electric motor rotor assembly, the at least two structural elements are connected solely via a single spring element. Vibration decoupling can consequently take place in a space-saving and effective fashion.

According to a further embodiment of the electric motor rotor assembly, the spring element can be an elastomeric spring, preferably be formed from a magnetically active elastomer. The elastomer itself can be produced cost-effectively and has sufficient spring properties, in particular within the field of vibration decoupling. Material from the electric motor on which the magnetic field could act is taken up by the elastomer. A magnetically active elastomer can therefore preferably be provided. The magnetically active elastomer has a higher magnetic permeability than the corresponding value of a pure elastomeric material. A spring element with significantly elevated magnetic conductivity is thus made possible. The magnetic field of the electric motor can therefore act optimally on the rotor and vibration decoupling can take place at the same time.

A magnetically active elastomer can be a composite of an elastomeric matrix and magnetizable particles embedded therein, in particular iron particles with a high saturation magnetization. Further advantages can consequently additionally be obtained when a magnetic field is applied. It is then possible to influence the spring stiffness by means of the particles because the strength of the magnetic field is linked to reversible changes in the viscoelastic properties, for example a rise in the memory modulus G′ and the loss modulus G″. In other words, the spring element made from a magnetically active elastomer can become stiffer as the field strength increases and softer as the field strength decreases.

According to a further embodiment of the electric motor rotor assembly, an inertial mass can be arranged on that one of the structural elements which is arranged on that side of the spring element which faces the central longitudinal axis. The inertial mass can be a separate component and/or not assume any other functions. The extent of the vibration decoupling can consequently be increased in terms of the frequency range and the magnitude, in particular in the case of an embodiment in which the inertial mass is arranged on a structural element which is mounted by means of bearings and thus “is freely suspended”. For example, a rotor shaft can be freely suspended. It is additionally conceivable that the inertial mass is arranged along a vibration path between two spring elements on a structural element mounted by means of bearings. Vibration decoupling can in particular be increased as a result.

According to a further embodiment of the electric motor rotor assembly, the spring element can form a form fit with at least one of the at least two structural elements. The form fit can act circumferentially. As a result, the spring element and the adjacent structural elements cannot twist critically relative to each other about the central longitudinal axis, as a result of which spinning is avoided. This embodiment therefore allows continued functioning in the event of failure of the spring element. This form fit can be made, for example, by means of a circumferential toothed contour or ribbed contour, running circumferentially, of the spring element. It is also conceivable that both circumferential sides of the spring element are contoured such that a toothed profile or ribbed profile is formed circumferentially. It is conceivable that the corresponding structural element has a circumferential contour corresponding to the circumferential contour. The two structural elements arranged on both sides of the spring element preferably have an overlap circumferentially. As a result, the spring element can be squeezed between the overlaps, as a result of which shearing of the spring element, and damage to it resulting therefrom, are avoided.

According to a further embodiment of the electric motor rotor assembly, the spring element can comprise at least one progressive cavity. The progressive cavity can extend in the longitudinal direction completely or only partially through the spring element, wherein the progressive cavity is preferably surrounded circumferentially completely by the material of the spring element in order to obtain an optimum progression. Because the progressive cavity extends in the longitudinal direction, the progression acts circumferentially. The progressive cavity results in a progressive torsion characteristic (soft for normal operation/hard for torsional impacts) because it closes beyond a certain angle of twisting of the two structural elements radially on both sides of the spring element.

According to a further embodiment of the electric motor rotor assembly, the spring element can comprise a separating element which separates the spring element into two radially adjacent spring element portions. As a result, the radial stiffness is preferably increased without, however, changing the torsional stiffness. As a result, as low as possible a stiffness ratio between torsion stiffness and radial stiffness can also be achieved. The spring element portions can have identical radial thicknesses in the longitudinal direction and/or in the circumferential direction in order to obtain uniform stresses. The separating element can be a separating sleeve on which in the radial direction the two spring element portions are arranged, preferably materially bonded, more preferably vulcanized. The separating element can be made from a plastic, preferably a thermoplastic, or a metal material. It is an advantage of the separating element that it only has to separate the two spring element portions in the radial direction, for which reason it can itself have a very small radial thickness, for example less than 1 mm.

According to a further embodiment of the electric motor rotor assembly, the spring element can have at least one rib projecting in a radial direction and extending in the longitudinal direction, preferably the spring element can have at least one outer rib projecting radially outward and extending in the longitudinal direction and/or at least one inner rib projecting radially inward and extending in the longitudinal direction. Additionally, at least one of the at least two structural elements can have a rib concavity corresponding to the rib, outer rib, or inner rib and into which the at least one rib, outer rib, or inner rib projects, preferably an outer radial rib concavity and/or an inner radial rib concavity.

Also as a result thereof, the spring element and the at least one structural element comprising a rib concavity and adjacent to the spring element cannot twist critically relative to each other about the central longitudinal axis, as a result of which spinning is avoided. This is true in particular for a spring element which does not have a material bond to the two radially adjacent structural elements. It is conceivable that the spring element comprises a separating element, wherein the separating element forms the rib, outer rib, or inner rib, for example by means of thickened material, such that the separating element has a greater radial thickness in the region of the rib, outer rib, or inner rib than in a region with no rib, outer rib, or inner rib, or for example by means of a circumferential profile such that the separating element has the same radial material thickness in the region of the rib, outer rib, or inner rib, and in a region with no rib, outer rib, or inner rib. In the first case, a very stiff separating element can be formed in which the rib, outer rib, or inner rib itself is/are barely or only slightly flexible. In the second case, a cost-effective separating element can be formed, the circumferential profile of which can be produced, for example, by means of shaping. It is conceivable that the separating element has a uniform radial material thickness in the circumferential direction. The spring element portions can have identical radial thicknesses in the longitudinal direction and/or in the circumferential direction in order to be stressed uniformly.

A rib, outer rib, or inner rib here engages into the corresponding rib concavity. If the spring element has in addition a separating element, this design serves simultaneously to prevent twisting and to increase the radial stiffness without, however, changing the torsional stiffness.

According to one conceivable embodiment of the electric motor rotor assembly, the spring element can have the same number of outer ribs and inner ribs, wherein the outer ribs and inner ribs can be arranged as unaligned in the radial direction. Adjacent outer ribs and inner ribs can therefore be offset relative to one another by an angle of offset with respect to the central longitudinal axis within the range from 5° to 10°. A torsional progression of the vibration decoupling can be achieved as a result. For example, when the two structural elements are twisted radially on both sides of the spring element about the central longitudinal axis, the unaligned arrangement causes the distance between two reference points on the structural elements to be reduced, for example the distance between a curved track or progression slope on one of the structural elements and, for example, a curved track or progression slope on the other of the structural elements. An air gap which may be present and which can be arranged in the circumferential direction between an outer rib or inner rib and the corresponding structural element can be closed by the twisting and the spring element can then also press there against the corresponding structural element. A torsional progression of the decoupling is achieved as a result.

According to a further embodiment of the electric motor rotor assembly, the at least one rib concavity can form a curved track and/or a progression slope along which the rib, outer rib, or inner rib can slide, in the case of relative movement in the circumferential direction between one of the structural elements which has the corresponding rib concavity and the spring element, and is consequently forced radially inward or radially outward. This is preferably also true for a spring element which has no material bond to the two radially adjacent structural elements. Progressive behavior can likewise be achieved by means of a curved track or progression slope, in particular where the spring element comprises a separating element. By virtue of the relative movement in the circumferential direction, the curved track and the progression slope of the corresponding rib, outer rib, or inner rib specify a movement direction which has radial fractions, as a result of which the spring element is then at the same time forced in the radial direction. An outwardly radial curved track or progression slope causes a force to be exerted radially inward, and an inwardly radial curved track or progression slope causes a force to be exerted radially outward.

According to one conceivable embodiment of the electric motor rotor assembly, the curved track can have a profile which flattens in the direction of a circumferential surface of the spring element. As a result, the spring element can increasingly be forced in the radial direction as the angle of twisting increases, which results in good progression. It is conceivable that rib concavities on the outer circumference each form a curved track which flattens in an opposite direction to the curved tracks which are formed by the rib concavities on the inner circumference. The curved tracks thus have opposite profiles in the circumferential direction. As a result, the direction of the relative movement in the circumferential direction is irrelevant because the progressive behavior can be achieved in both directions.

According to one conceivable embodiment of the electric motor rotor assembly, the progression slope can have a level profile and/or be tilted relative to the radial direction or enclose a tilt angle with the radial direction. The progression slope can be set by means of the angle. It is conceivable that the rib concavity forms two progression slopes, namely one on each side of the rib, outer rib, or inner rib in the circumferential direction, and the tilt angles of the two progression slopes of a rib concavity are preferably the same in order to obtain an identical progression behavior irrespective of the direction of the relative movement in the circumferential direction.

According to a further embodiment of the electric motor rotor assembly, an air gap can be arranged in the circumferential direction between a rib, outer rib, or inner rib and the corresponding rib concavity. The air gap can be present over the whole radial overlapping height between the rib, outer rib, or inner rib and the corresponding rib concavity. It is conceivable that an air gap is arranged in the circumferential direction on each side of the rib, outer rib, or inner rib. As a result, the rib, outer rib, or inner rib can be arranged so that it is spaced apart from the adjacent structural element on both sides in the circumferential direction in order to achieve a torsional progression of the decoupling irrespective of the direction of the relative movement in the circumferential direction. When the two structural elements twist radially on both sides of the spring element about the central longitudinal axis, namely the corresponding air gap first closes before the spring element bears there against the structural element.

According to one conceivable embodiment of the electric motor rotor assembly, at least one bearing can be provided, preferably a plain bearing or a rolling bearing, which mounts at least one of the structural elements on a housing, in particular on an electric motor housing, and/or on a flywheel. By virtue of the bearing, in particular the rolling bearing, the radial and/or cardanic and/or axial degree of freedom can be eliminated. In order to meet, for example, high requirements on gap size and imbalances, it can be advantageous to eliminate these degrees of freedom. The torsional degree of freedom, which has an influence on the vibration decoupling, continues, however, to be present.

According to one conceivable embodiment of the electric motor rotor assembly, the spring element or the spring element portions have a maximum radial thickness of 4 mm. The sum of the individual radial thicknesses of the two spring element portions can thus be no more than 4 mm. These dimensions are an advantageous compromise between sufficient vibration decoupling and as little as possible influence on the magnetic field.

According to one conceivable embodiment of the electric motor rotor assembly, one of the structural elements can be a rotor shaft and the at least one spring element can be carried by the rotor shaft. The rotor shaft can be a solid shaft, a hollow shaft, or a hub. The arrangement of the spring element on the rotor shaft results, because of a certain inertia of the rotor shaft, in advantageous vibration decoupling in the torsional direction above a certain frequency and thus reduces the high-frequency noise level.

According to one conceivable embodiment of the electric motor rotor assembly, one of the structural elements can be a rotor base body and the at least one spring element can bear against the rotor base body. As a result, the spring element can vibration-decouple the rotor base body from the other structural element, for example the rotor shaft. The rotor base body can take the form of a lamination stack and/or serve as a support for permanent magnets. The base body can be connected to the rotor shaft via the spring element. The base body can have an essentially cylindrical shape and extends along an axis of rotation of the rotor shaft. When the spring element is arranged between the rotor base body and the rotor shaft, the spring element means that the rotor shaft is a “freely suspended torsion element” and, by virtue of the inherent inertia, serves to decouple vibration in addition to its main purpose, the transmission of force. This shows the variability of the invention.

According to one conceivable embodiment of the electric motor rotor assembly, one of the structural elements can be a transmission input gearwheel and the at least one spring element can bear against the transmission input gearwheel. As a result, the spring element can vibration-decouple the transmission input gearwheel from the other structural element, for example the rotor shaft. When the spring element is arranged between the transmission input gearwheel and the rotor shaft, the spring element means that the rotor shaft is a “freely suspended torsion element” and, by virtue of the inherent inertia, serves to decouple vibration in addition to its main purpose, the transmission of force. This likewise shows the variability of the invention.

According to one conceivable embodiment of the electric motor rotor assembly, a first spring element can be arranged between the rotor base body and the rotor shaft and a second spring element can be arranged between the transmission input gearwheel and the rotor shaft. The provision of two such spring elements results in torsional elasticity at two locations with a low torque (for example, on a primary side of the transmission) and a certain inertia between them which is achieved by the rotor shaft, and advantageously results in pronounced torsional vibration decoupling above a certain frequency and thus reduces the high-frequency noise level.

According to one conceivable embodiment of the electric motor rotor assembly, the at least two structural elements can be first and second portions of a rotor shaft or first and second portions of a rotor base body or first and second portions of a transmission input gearwheel. As a result, the spring element can be arranged inside a single component which is consequently divided.

According to one conceivable embodiment of the electric motor rotor assembly, the at least one spring element can either be materially bonded, preferably vulcanized, to one or both radially adjacent structural elements or be arranged between the two radially adjacent structural elements with no material bonding. A material bond enables a cost-effective and permanent connection. An arrangement with no material bonding, in which the at least one spring element is retained by means of a form and/or force fit, enables a relative movement of the spring element with respect to at least one adjacent structural element and, in the case of a corresponding configuration, also progressive behavior.

### BRIEF DESCRIPTION OF THE DRAWINGS

Further features, details, and advantages of the invention can be found in the wording of the claims and in the following description of the exemplary embodiments on the basis of the drawings, in which:

FIG. 1 shows a view in longitudinal section of an electric motor / transmission unit with an electric motor rotor assembly;

FIG. 2 shows a view in cross section of two structural elements with a spring element;

FIG. 3 shows a view in cross section of a spring element portion;

FIG. 4 shows a view in longitudinal section of a spring element portion;

FIG. 5 shows a view in cross section of two structural element portions with a spring element;

FIG. 6 shows a view in cross section of two structural elements with a spring element in a further embodiment;

FIG. 7 shows a view in cross section of two structural elements with a spring element in a further embodiment; and

FIG. 8 shows a graph of the amplitude of the torsional vibration as a function of the excitation frequency.

### DETAILED DESCRIPTION

Elements which are the same or correspond with one another are designated in each case in the Figures with the same reference signs and are therefore not described again, unless it is appropriate to do so. Features which have already been described will not be described again in order to avoid repetitions and can be applied to all elements with the same or corresponding reference signs, unless explicitly excluded. The content disclosed in the entirety of the description can analogously be transferred to the same parts with the same reference signs or the same component names. The positional specifications chosen in the description, such as for example above, below, side, etc, are also made with reference to the Figure being described and illustrated and, in the case of a change in position, are to be transferred analogously to the new position. Furthermore, individual features or combinations of features from the different exemplary embodiments shown and described represent solutions which are inherently independent, inventive, or according to the invention.

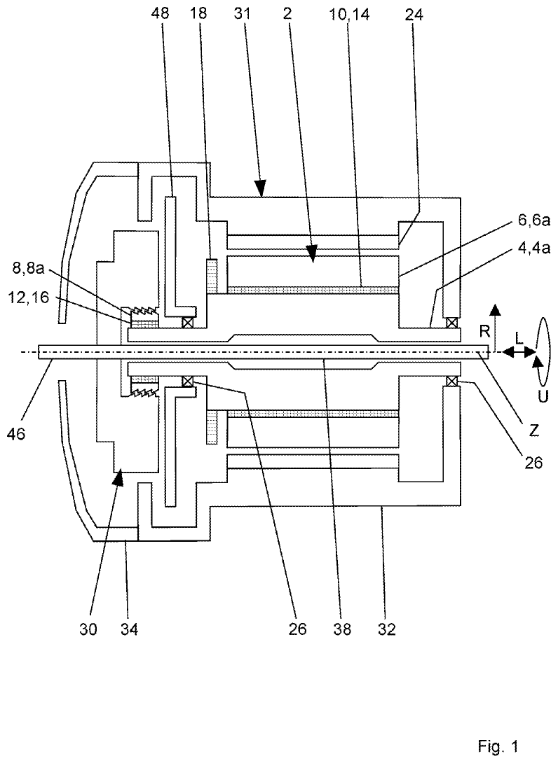

FIG. 1 shows a view in longitudinal section through an electric motor 31 which comprises an electric motor housing 32. A transmission 30 which comprises a transmission housing 34 is flange-mounted on the electric motor 31. The electric motor 31 comprises a stator 24 and an electric motor rotor assembly 2 which is traversed in the longitudinal direction L by a central longitudinal axis Z. A radial direction R extends therefrom and a circumferential direction U extends about the central longitudinal axis Z.

The electric motor rotor assembly 2 comprises, in the example shown, three rigid structural elements 4, 6, 8, wherein the structural element 4 is a rotor shaft 4a. It is illustrated here as a hollow shaft and a drive shaft 28, which can connect the transmission 30 to a wheel (not illustrated), engages through it in the longitudinal direction L. The rotor shaft 4a is mounted via bearings 26 on the electric motor housing 32 and on a flywheel 48.

A further structural element 6 is a rotor base body 6a. The rotor base body 6a takes the form of a lamination stack and/or serves as a support for permanent magnets. The structural elements 4, 6 or the rotor shaft 4a and the rotor base body 6a are arranged coaxially with respect to the central longitudinal axis Z, wherein the rotor base body 6a is arranged on the outer circumference of the rotor shaft 4a. A spring element 10 in the form of a sleeve-like elastomeric spring 14 is arranged in the radial direction R between the rotor shaft 4a and the rotor base body 6a. The spring element 10 is vulcanized on there. The rotor shaft 4a and the rotor base body 6a are vibration-uncoupled by the spring element 10, wherein the rotor shaft 4a and the rotor base body 6a are connected solely via the one spring element 10.

A further structural element 8 is a transmission input gearwheel 8a. The transmission input gearwheel 8a is the first gearwheel, facing the electric motor 31, of the transmission 30. The transmission input gearwheel 8a is also arranged coaxially with respect to the central longitudinal axis Z, wherein the transmission input gearwheel 8a is arranged on the outer circumference of the rotor shaft 4a. A spring element 12 in the form of a sleeve-like elastomeric spring 16 is arranged in the radial direction R between the rotor shaft 4a and the transmission input gearwheel 8a. The spring element 12 is vulcanized on there. The rotor shaft 4a and the transmission input gearwheel 8a are vibration-uncoupled by the spring element 12, wherein the rotor shaft 4a and the transmission input gearwheel 8a are connected solely via the one spring element 10.

The arrangement of the spring elements 10, 12 in the first place between the rotor base body 6a and the rotor shaft 4a and in the second place between the transmission input gearwheel 8a and the rotor shaft 4a means that the rotor shaft 4a “is a freely suspended torsion element”. It is additionally shown that the three structural elements 4, 6, 8 are arranged immediately behind one another along a vibration path.

The structural element 4 or the rotor shaft 4a carries a ring-shaped inertial mass 18. The inertial mass 18 is a separate component from the rotor shaft 4a and is considered to have no function beyond that of providing additional mass. It can additionally be seen that the inertial mass 18 is arranged along the vibration path between the two spring elements 10, 12 on the structural element 4 mounted by means of bearings 26 or on the rotor shaft 4a.

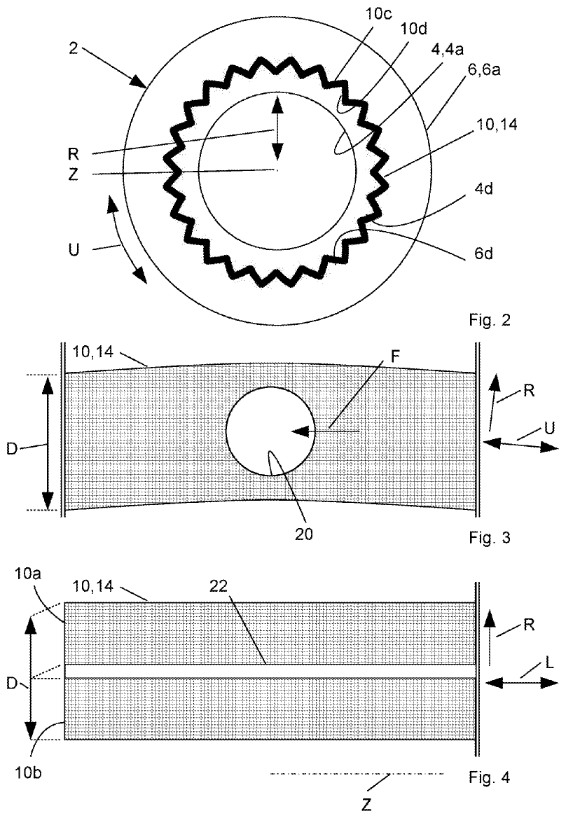

A view in cross section of the structural element 4 as a rotor shaft 4a and the structural element 6 as a rotor base body 6a with a spring element 10, arranged radially in between and preferably vulcanized on, as an elastomeric spring 14 is depicted in FIG. 2. The spring element 10 has a toothed profile which runs in the circumferential direction U and engages in form-fitting fashion in corresponding toothed contours of the structural elements 4, 6. The toothed contour 10c on the outer circumference of the spring element 10 and the toothed contour 10d on the inner circumference of the spring element 10 result in a toothed profile of the spring element 10 in the circumferential direction. The two toothed contours 10c, 10d of the spring element engage in toothed contours 4d, 6d with corresponding contours in the adjacent structural elements 4, 6. It can additionally be seen that the teeth of the toothed contour 4d of the structural element 4 project a certain distance into the toothed contour 6d of the structural element 6, as a result of which an overlap in the circumferential direction U results.

FIG. 3 depicts a view in cross section of a portion of a spring element 10 as an elastomeric spring 14. The spring element 10 has a radial thickness D of no more than 4 mm. A cylindrical progressive cavity 20 extends in the longitudinal direction L through the spring element 10, wherein the progressive cavity 20 is surrounded circumferentially completely by the material of the spring element 10. Twisting of the two adjacent structural elements (not depicted in FIG. 3) by a certain angle of twisting with respect to the central longitudinal axis Z then results in a force F acting on the spring element 10 and the progressive cavity 20 closing or being reduced.

A view in longitudinal section of a portion of a spring element 10 as an elastomeric spring 14 is depicted in FIG. 4. The spring element 10 comprises a separating element 22 which takes the form of a separating sleeve. The separating element 22 is vulcanized into the spring element 10 and divides the spring element 10 into two spring element portions 10a, 10b of the same thickness. It can therefore additionally be seen that the sum of the individual radial thicknesses of the two spring element portions 10a, 10b can thus be no more than 4 mm, i.e. corresponds to the radial thickness D.

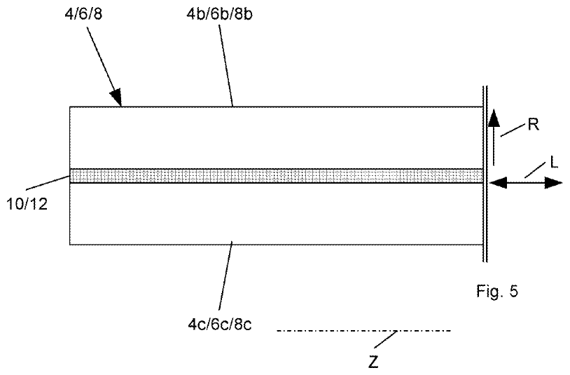

A different arrangement of a spring element 10 is shown in a view in cross section in FIG. 5, wherein the generally applicable character of this Figure is indicated by means of reference signs. Namely, the spring element 10 or the spring element 12 is no longer arranged between two separate components and instead inside a single component such as, for example, inside the structural element 4 as the rotor shaft 4a, for which reason the latter is divided into a rotor shaft portion 4b on the outer circumference and a rotor shaft portion 4c on the inner circumference. Similarly, the structural element 6 as the rotor base body 6a can also be divided into a rotor base body portion 6b on the outer circumference and a rotor base body portion 6c on the inner circumference. This can also apply for the structural element 8 as the transmission input gearwheel 8a and hence it can be divided into a transmission input gearwheel portion 8b on the outer circumference and a transmission input gearwheel portion 8c on the inner circumference.

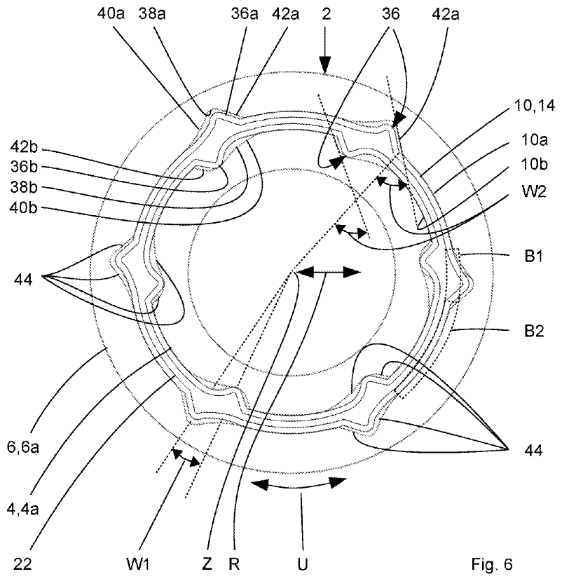

Depicted in FIG. 6 is a view in cross section of the structural element 4 as the rotor shaft 4a and of the structural element 6 as the rotor base body 6a with a spring element 10, arranged radially in between, as the elastomeric spring 14 which has a separating element 22 as a separating sleeve. The spring element 10 here has no material bond to the adjacent structural elements 4, 6.

The spring element 10 has a plurality of ribs 36, in this case twelve by way of example, which project in the radial direction R and extend in the longitudinal direction L. To be more precise, the spring element 10 comprises a plurality of outer ribs 36a, in this case six by way of example, which project radially outward and a plurality of inner ribs 36b, in this case six by way of example, which project radially inward. The outer ribs 36a and inner ribs 36b are arranged in each case equidistantly from one another in the circumferential direction U. The outer ribs 36a and inner ribs 36b are arranged as unaligned in the radial direction R and are offset relative to one another by an angle of offset W1 with respect to the central longitudinal axis.

The separating element 22 forms the ribs 36 or outer ribs 36a and inner ribs 36b by virtue of the fact that it has thickened material such that the separating element 22 has a greater radial material thickness in the region B1 of the ribs 36 or outer ribs 36a and inner ribs 36b than in a region B2 with no ribs 36 or outer ribs 36a and inner ribs 36b. The separating element 22 is provided at the circumference with the spring element portions 10a, 10b which have identical radial thicknesses in the longitudinal direction L and in the circumferential direction U.

The structural element 6 as the rotor base body 6a then has rib concavities 38a corresponding to the outer ribs 36a. One of the outer ribs 36a projects into each of the rib concavities 38a, wherein two air gaps 44 are arranged in the circumferential direction U between one of the outer ribs 36a and the corresponding rib concavity 38a. In each case one air gap 44 is therefore arranged in the circumferential direction U on each side of the outer ribs 36a.

The structural element 4 as the rotor shaft 4a then likewise has rib concavities 38b corresponding to the inner ribs 36b. One of the inner ribs 36b projects into each of the rib concavities 38b, wherein two air gaps 44 are arranged in the circumferential direction U between one of the inner ribs 36b and the corresponding rib concavity 38b. In each case one air gap 44 is therefore arranged in the circumferential direction U also on each side of the inner ribs 36b.

It can be seen that the rib concavities 38a, 38b in each case form a curved track 40a, 40b along which the ribs 36 or outer ribs 36a and inner ribs 36b can slide in the case of relative movement in the circumferential direction U between the structural elements 4, 6. The outer radial curved tracks 40a cause, in the case of relative movement, the spring element 10 to be forced inward in the radial direction R toward the central longitudinal axis Z, whereas the inner radial curved tracks 40b cause, in the case of relative movement, the spring element 10 to be forced outward in the radial direction R away from the central longitudinal axis Z.

It can additionally be seen that the rib concavities 38a, 38b in each case also form a progression slope 42a, 42b along which the ribs 36b or outer ribs 36a and inner ribs 36b can slide in the case of relative movement in the circumferential direction U between the structural elements 4, 6. The outer radial progression slopes 42a cause, in the case of relative movement, the spring element 10 to be forced inward in the radial direction R toward the central longitudinal axis Z, whereas the inner radial progression slopes 42b cause, in the case of relative movement, the spring element 10 to be forced outward in the radial direction R away from the central longitudinal axis Z. The progression slopes 42a, 42b in each case have a level profile and are tilted relative to the radial direction R, for which reason they enclose a tilt angle W2 with each other.

In this embodiment, a curved track 40a, 40b and a progression slope 42a, 42b are situated opposite each other with respect to the corresponding rib concavities 38a, 38b. Thus, a curved track 40a, 40b is arranged in the circumferential direction U on one side of each rib 36 or outer rib 36b and inner rib 36b, and a progression slope 42a, 42b on the other side.

The outer radial curved tracks 40a have in each case a profile which flattens in the direction of the outer circumferential surface of the spring element 10. The inner radial curved tracks 40b likewise in each case have a profile which flattens in the direction of the inner circumferential surface of the spring element 10. Advantageously, the outer radial curved tracks 40a and the inner radial curved tracks 40b flatten in opposite directions with respect to the circumferential direction U, as a result of which profiles running in opposite directions in the circumferential direction U of the curved tracks 40a, 40b are obtained.

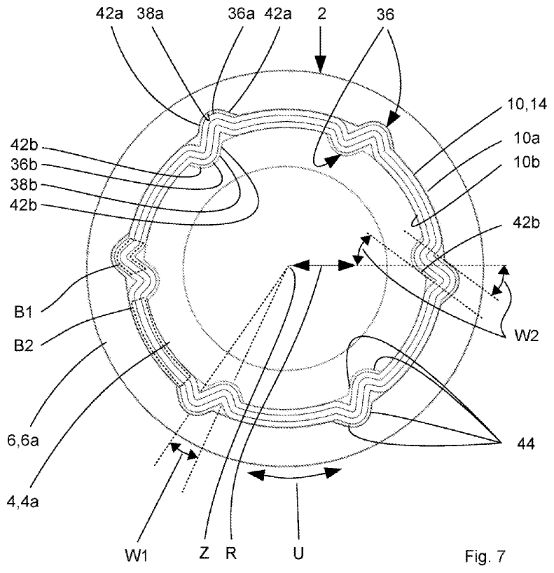

A cross section of the structural element 4 as the rotor shaft 4a and of the structural element 6 as the rotor base body 6a with the spring element 10, arranged radially in between, as an elastomeric spring 14, and which has a separating element 22 as a separating sleeve, is depicted in FIG. 7. Because the electric motor rotor assembly 2 of FIG. 7 is similar to that in FIG. 6, in order to avoid repetition, only the differences in FIG. 7 from FIG. 6 will be described. Features that are not described are equally to be considered as disclosed and described.

The separating element 22 forms the ribs 36 or outer ribs 36a and inner ribs 36b by means of a corresponding circumferential profile. The separating element 22 thus has the same radial material thickness in the region B1 of the ribs 36 or outer ribs 36a and inner ribs 36b and in a region B2 with no ribs 36 or outer ribs 36a and inner ribs 36b. The circumferential profile can be produced, for example, by means of shaping of the separating element 22.

The rib concavities 38a, 38b now no longer have curved tracks 40a, 40b. Instead, each rib concavity 38a, 38b has two progression slopes 42a, 42b such that a progression slope 42a, 42b is formed in each case on each side in the circumferential direction U of the corresponding rib 36 or outer rib 36a and inner rib 36b. The progression slopes 42a, 42b of a rib concavity 38a, 38b can have the same tilt angle W2, and preferably all the tilt angles W2 of the progression slopes 42a, 42b of the rib concavities 38a, 38b are the same.

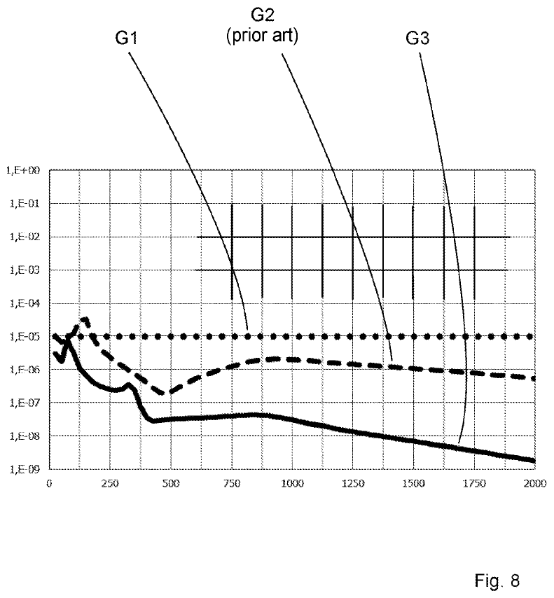

The efficiency of the electric motor rotor assembly 2 according to the invention compared with a known and rigid rotor is depicted in FIG. 8. The amplitude of the torsional vibration in rad (y axis) is plotted against the frequency in Hz (x axis). A rotor known from the prior art has been excited by means of an excitation frequency which is referred to as the rotor excitation G1. A vibration response, referred to as the vibration response with no spring element G2, has been measured at a housing of the known rotor. The electric motor rotor assembly 2 has also been excited by means of this rotor excitation G1. A vibration response, referred to as the vibration response with a spring element G3, has been measured at a housing of the electric motor rotor assembly.

It can be seen that the electric motor rotor assembly 2 according to the invention causes over the whole measured frequency a lower, sometimes considerably lower, vibration response, in particular in the higher frequency range.

The invention is not limited to one of the above described embodiments and instead can be modified in numerous fashions. All of the features and advantages which can be found in the claims, the description, and the drawings, including structural details, physical arrangements, and method steps, can be essential to the invention both per se and in many different combinations.

All combinations of at least two of the features disclosed in the description, the claims, and/or the Figures fall within the scope of the invention.

In order to avoid repetitions, features disclosed in accordance with the device are to be considered as disclosed and claimable also in accordance with the method. Likewise, features disclosed in accordance with the method are to be considered as disclosed and claimable in accordance with the device.

1. An electric motor rotor assembly, comprising:
a central longitudinal axis which traverses the electric motor rotor assembly,
at least two structural elements arranged coaxially with respect to the central longitudinal axis, and
at least one spring element arranged between the at least two structural elements in a radial direction (R) and connecting the corresponding at least two structural elements to each other so that they can move relatively.

2. The electric motor rotor assembly as claimed in claim 1, wherein the spring element is an elastomeric spring formed from a magnetically active elastomer.

3. The electric motor rotor assembly as claimed in claim 1, wherein an inertial mass is arranged on that at least one of the at least two structural elements which is arranged on that side of the spring element which faces the central longitudinal axis.

4. The electric motor rotor assembly as claimed in claim 1, wherein the spring element forms a form fit with at least one of the at least two structural elements.

5. The electric motor rotor assembly as claimed in claim 1, wherein the spring element comprises at least one progressive cavity.

6. The electric motor rotor assembly as claimed in claim 1, wherein the spring element comprises a separating element which separates the spring element into two radially adjacent spring element portions.

7. The electric motor rotor assembly as claimed in claim 6, wherein the spring element has at least one rib projecting in the radial direction and extending in a longitudinal direction, the spring element has outer ribs projecting radially outward and extending in the longitudinal direction and/or inner ribs projecting radially inward and extending in the longitudinal direction, and in that at least one of the at least two structural elements has a rib concavity corresponding to the rib, outer rib, or inner rib and into which the at least one rib, outer rib, or inner rib projects, an outer radial rib concavity and/or an inner radial rib concavity.

8. The electric motor rotor assembly as claimed in claim 7, wherein the at least one rib concavity forms a curved track and/or a progression slope along which the rib, outer rib, or inner rib can slide, in the case of relative movement in a circumferential direction between one of the structural elements which has the corresponding rib concavity and the spring element, and is consequently forced radially inward or radially outward.

9. The electric motor rotor assembly as claimed in claim 7, wherein an air gap is arranged in a circumferential direction between a rib, outer rib, or inner rib and the corresponding rib concavity.

10. The electric motor rotor assembly as claimed in claim 8, wherein an air gap is arranged in the circumferential direction between a rib, outer rib, or inner rib and the corresponding rib concavity.

11. The electric motor rotor assembly as claimed in claim 2, wherein the spring element is formed from a magnetically active elastomer.

12. The electric motor rotor assembly as claimed in claim 7, wherein the at least one rib, outer rib, or inner rib projects into an outer radial rib concavity and/or an inner radial rib concavity.
